(19) United States
(12) Patent Application Publication
(10) Pub. No.: US 2021/0352341 A1
(43) Pub. Date: Nov. 11, 2021

(54) SCENE CUT-BASED TIME ALIGNMENT OF VIDEO STREAMS

(71) Applicant: AT&T Intellectual Property I, L.P., Atlanta, GA (US)

(72) Inventors: Peshala Pahalawatta, Burbank, CA (US); Roberto Nery da Fonseca, Redondo Beach, CA (US); Manuel A. Briand, Santa Monica, CA (US)

(21) Appl. No.: 16/867,901

(22) Filed: May 6, 2020

(51) Int. Cl. H04N 21/234; H04N 21/845; H04N 21/24; H04N 21/258; H04N 21/2343

(52) U.S. Cl. CPC H04N 21/23418; H04N 21/8456; H04N 21/2343; H04N 21/25841; H04N 21/24

(57) ABSTRACT

An example method performed by a processing system includes detecting a first scene cut in a source video that is provided as an input to a video distribution system. The video distribution system includes a plurality of processing stages for transforming the source video into a processed video that is suitable for distribution to viewers. The first scene cut is detected in the processed video that is output by the video distribution system. The processed video is a version of the source video that has been altered according to at least one of the plurality of processing stages. A first sub-segment of the source video is time-aligned with a second sub-segment of the processed video, using the first scene cut as a reference point for performing the time-aligning. A difference is computed between a picture quality metric of the first sub-segment and a picture quality metric of the second sub-segment.

The present disclosure relates generally to live streaming of media, and relates more particularly to devices, non-transitory computer-readable media, and methods for aligning video streams based on scene cuts.

### BACKGROUND

Streaming of media, such as video, over networks such as the Internet has become one of the most popular ways for consumers to enjoy media. In many cases, streaming has even become more popular than conventional media distribution methods such as network and cable television, terrestrial radio, and the like. For instance, growing numbers of consumers are cancelling cable television service in favor of video streaming services. Moreover, growing numbers of media providers are launching their own streaming services in order to cater to these consumers.

### BRIEF DESCRIPTION OF THE DRAWINGS

The teachings of the present disclosure can be readily understood by considering the following detailed description in conjunction with the accompanying drawings, in which:

FIG. 1 illustrates an example system in which examples of the present disclosure for scene cut-based time-alignment of video streams may operate;

FIG. 2 is a block diagram illustrating one example of the application server of FIG. 1, according to the present disclosure;

FIG. 3 is a flowchart illustrating one example of a method for measuring the picture quality of a video stream, in accordance with the present disclosure;

FIG. 4 is a diagram illustrating how an example source video may be time-aligned with an example processed video based on scene cuts, according to the present disclosure;

FIG. 5 illustrates one example of a commonality matrix that may be used to detect matching scene cuts in a source video and a corresponding processed video, according to the present disclosure; and

FIG. 6 illustrates a high level block diagram of a computing device specifically programmed to perform the steps, functions, blocks and/or operations described herein.

To facilitate understanding, identical reference numerals have been used, where possible, to designate identical elements that are common to the figures.

### DETAILED DESCRIPTION

The present disclosure describes a device, computer-readable medium, and method for scene cut-based time alignment of video streams. For instance, in one example, a method performed by a processing system includes detecting a first scene cut in a source video that is provided as an input to a video distribution system, wherein the video distribution system comprises a plurality of processing stages for transforming the source video into a processed video that is suitable for distribution to viewers, detecting the first scene cut in the processed video that is output by the video distribution system, wherein the processed video comprises a version of the source video that has been altered according to at least one processing stage of the plurality of processing stages, time-aligning a first sub-segment of the source video with a second sub-segment of the processed video, using the first scene cut as a reference point for performing the time-aligning, and computing a difference between a picture quality metric of the first sub-segment and a picture quality metric of the second sub-segment.

In another example, a system includes a processing system including at least one processor and a non-transitory computer-readable medium storing instructions which, when executed by the processing system, cause the processing system to perform operations. The operations include detecting a first scene cut in a source video that is provided as an input to a video distribution system, wherein the video distribution system comprises a plurality of processing stages for transforming the source video into a processed video that is suitable for distribution to viewers, detecting the first scene cut in the processed video that is output by the video distribution system, wherein the processed video comprises a version of the source video that has been altered according to at least one processing stage of the plurality of processing stages, time-aligning a first sub-segment of the source video with a second sub-segment of the processed video, using the first scene cut as a reference point for performing the time-aligning, and computing a difference between a picture quality metric of the first sub-segment and a picture quality metric of the second sub-segment.

In another example, a non-transitory computer-readable medium stores instructions which, when executed by a processing system including at least one processor, cause the processing system to perform operations. The operations include detecting a first scene cut in a source video that is provided as an input to a video distribution system, wherein the video distribution system comprises a plurality of processing stages for transforming the source video into a processed video that is suitable for distribution to viewers, detecting the first scene cut in the processed video that is output by the video distribution system, wherein the processed video comprises a version of the source video that has been altered according to at least one processing stage of the plurality of processing stages, time-aligning a first sub-segment of the source video with a second sub-segment of the processed video, using the first scene cut as a reference point for performing the time-aligning, computing a difference between a picture quality metric of the first sub-segment and a picture quality metric of the second sub-segment, determining that the difference between the picture quality metric of the first sub-segment and the picture quality metric of the second sub-segment is greater than a predefined threshold, computing an adjustment to a parameter of the video distribution system, wherein the adjustment causes the difference between the picture quality metric of the first sub-segment and the picture quality metric of the second sub-segment to be smaller than the predefined threshold, and sending an instruction to the video distribution system, wherein the instruction causes the parameter to be dynamically adjusted according to the adjustment.

As discussed above, streaming of media, such as video, over the Internet has become one of the most popular ways for consumers to enjoy media. In many cases, streaming has even become more popular than conventional media distribution methods such as network and cable television, terrestrial radio, and the like. A typical video distribution system for distributing streaming video may take a source video as input, apply one or more processing techniques to facilitate streaming (e.g., compression, transcoding of different bitrate variants, etc.), and output a processed video for distribution to viewers. Ideally, the video picture quality of the processed video should match the video picture quality of the source video.

In order to efficiently allocate network resources while providing the best possible video picture quality, it is necessary to obtain accurate measurements of the video picture quality. When streaming live (as opposed to pre-recorded) video, the video picture quality must be measured as the video is being processed by the video distribution system, while the video distribution system is operating in a known configuration. In general, there are two primary methods of measuring video picture quality: subjective measurement using human viewers and objective measurement using a scoring system.

During subjective measurement, human viewers may be asked to view a processed video sequence and rate the perceived quality of the picture according to some scale (e.g., one to ten, poor/fair/good/excellent, etc.). Although subjective testing provides a true indication of the perceptual picture quality (i.e., the picture quality as actually perceived by viewers), subjective testing is also expensive, time consuming, and unsuitable for real-time testing (e.g., for streaming of live video).

During objective measurement, a test system may measure the degradation in the picture quality of the video from system input (e.g., source video) to system output (e.g., processed video), using metrics such as peak signal-to-noise ratio (PSNR), structural similarity (SSIM), video multimethod assessment fusion (VMAF), and/or other full reference (FR) quality metrics. Although objective measurement tends to be more efficient than subjective measurement from a time and cost perspective, the accuracy of objective measurement may be compromised if the source video is not perfectly time-aligned to the processed video. For instance, an offset of even a single frame (e.g., approximately seventeen milliseconds of video) may result in a significant degradation in the accuracy of the metrics.

Moreover, in live or linear video distribution systems, where the source video may be processed through a video processing chain that comprises a plurality of processing stages (e.g., scaling, deinterlacing, denoising, compression, transcoding to one or more different bitrates, etc.), alignment of the source video to the processed video becomes even more challenging, since each processing stage may introduce a delay that shifts the alignment of the input and output video frames. Conventional approaches to aligning the source video with the processed video include manual alignment by a human operator, inserting an alignment pattern (e.g., frame) that is machine-detectable in both the source video and the processed video, and pixel-wise frame differencing.

Manual alignment tends to be time consuming and expensive. Insertion of an alignment pattern is not always possible when working with a live or linear workflow, because the input to the workflow (i.e., the source video) is often provided as a compressed bitstream. In this case, insertion of the alignment pattern would therefore involve decoding the source video from the bitstream so that the alignment pattern can be inserted, and then re-encoding the source video with the inserted alignment pattern prior to analysis by the test system. The decoding and re-encoding may increase the computational costs and latency of the testing as well as unintentionally degrade the video picture quality. Moreover, if the video distribution system is proprietary to a specific vendor, it may not be possible to access the uncompressed source video to insert an alignment pattern prior to processing the video in the system.

Pixel-wise frame differencing involves computing a metric (e.g., mean squared error (MSE)) between pixels of a first frame in the source video and pixels of a corresponding second frame in the processed video. If the metric is below a specified threshold, then it is likely that the first frame and the second frame are aligned in time. Thus, the metric may be computed for a plurality of different pairs of frames (e.g., at least one frame from the source video and at least one corresponding frame from the processed video), and the pair of frames for which the metric is smallest may be considered to be the best point of reference for aligning the videos. This approach can be made more robust by calculating the average MSE over a window of frames (e.g., x sequential or neighboring frames in each direction). However, pixel-wise frame differencing is computationally intense. In the worst case, this approach involves computing on the order of N×M×W pixel-wise frame differences (for a source sequence of N frames, a processed sequence of M frames, and a window size of W frames). Thus, pixel-wise frame differencing works best when the offset between the source video and the processed video is relatively small to begin with. Moreover, pixel-wise frame differencing tends not to be robust to factors such as scaling differences between the source video and the processed video, cropping or horizontal shifts in the picture from the source video to the processed video, and global luminance shifts between the source video and the processed video.

As a further consideration, in a practical live video distribution system, the processed video sequence that is output may occasionally skip ahead a few frames, or freeze for a few frames before skipping ahead. In such cases, it may not be possible to perfectly align all frames of the source video with all frames of the processed video.

Examples of the present disclosure provide a novel method for aligning source and processed video sequences to facilitate measurement of video picture quality. In one example, scene cuts are used to align the source video to the processed video. Scene cuts may occur, for example, when a video transitions from one shot to another (e.g., switching from one camera shot to another in a single scene, switching from one scene to another, or even switching between programming, such as might occur when switching from a main program to a commercial). Once the same sequence of scene cuts is detected in the source video and the processed video, the method may attempt to align a maximum number of contiguous frames of the source video and the processed video, using the first scene cut in the sequence of scene cuts as a reference point. Scene cut detection is robust to common video processing techniques such as scaling, deinterlacing, lossy compression, and the like; as such, it is expected that scene cuts can be easily detected in both the source video and the processed video.

Once the source video and the processed video have been properly aligned in time, any degradations in video picture quality (from the source video to processed video) can be accurately detected and measured. Information about degradations in video picture quality can, in turn, be provided to an optimization routine that may compute an adjustment to the configuration of at least one processing stage of the video distribution system in order to improve the video picture quality of the processed video.

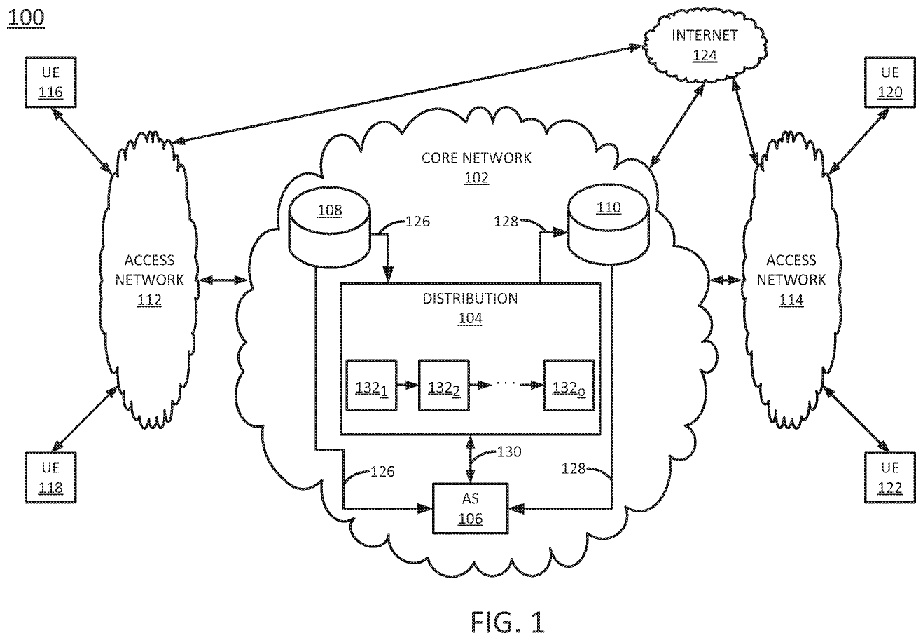

It should also be noted that although examples of the present disclosure are described primarily in connection with a video client and video streaming, examples of the present disclosure may be similarly applied to other types of streaming media, including streaming audio. In addition, although aspects of the present disclosure may be most applicable in the context of live streaming, the present disclosure may be equally applicable to on-demand streaming of recorded programs. Furthermore, although the novel alignment technique disclosed herein is discussed within the context of measuring video quality, the alignment technique may be used to facilitate any process in which media streams may be aligned (e.g., co-viewing of video streams and other processes). For instance, the media streams may be audio-visual streams of a server-side multi-tenant delivery platform in which the server may ingest video streams from either content providers or users/members of a streaming video service who wish to enable co-viewing with other users/members of the same streaming video service. In such cases, the incoming video streams received by the delivery platform may be extremely diverse (in terms of distance to the server, stream type, and/or the like), making time alignment of the diverse video streams essential to supporting functions such as co-viewing. These and other aspects of the present disclosure are described in greater detail below in connection with the examples of FIGS. 1-6.

To further aid in understanding the present disclosure, FIG. 1 illustrates an example system 100 in which examples of the present disclosure for scene cut-based time-alignment of video streams may operate. The system 100 may include any one or more types of communication networks, such as a traditional circuit switched network (e.g., a public switched telephone network (PSTN)) or a packet network such as an Internet Protocol (IP) network (e.g., an IP Multimedia Subsystem (IMS) network), an asynchronous transfer mode (ATM) network, a wired network, a wireless network, and/or a cellular network (e.g., 2G-5G, a long term evolution (LTE) network, and the like) related to the current disclosure. It should be noted that an IP network is broadly defined as a network that uses Internet Protocol to exchange data packets. Additional example IP networks include Voice over IP (VoIP) networks, Service over IP (SoIP) networks, the World Wide Web, and the like.

In one example, the system 100 may comprise a core network 102. The core network 102 may be in communication with one or more access networks 112 and 114, and with the Internet 124. In one example, the core network 102 may combine core network components of a wired or cellular network with components of a triple play service network; where triple-play services include telephone services, Internet services and television services to subscribers. For example, the core network 102 may functionally comprise a fixed mobile convergence (FMC) network, e.g., an IP Multimedia Subsystem (IMS) network. In addition, the core network 102 may functionally comprise a telephony network, e.g., an Internet Protocol/Multi-Protocol Label Switching (IP/MPLS) backbone network utilizing Session Initiation Protocol (SIP) for circuit-switched and Voice over Internet Protocol (VoIP) telephony services. The core network 102 may further comprise a broadcast television network, e.g., a traditional cable provider network or an Internet Protocol Television (IPTV) network, as well as an Internet Service Provider (ISP) network. In one example, the core network 102 may include a plurality of television (TV) servers (e.g., a broadcast server, a cable head-end), a plurality of content servers, an advertising server (AS), an interactive TV/video on demand (VoD) server, and so forth (not shown). As further illustrated in FIG. 1, the core network 102 may include a media distribution system 104, an application server (AS) 106, a first database (DFB) 108, and a second DB 110. For ease of illustration, various additional elements of the core network 102 are omitted from FIG. 1.

In one example, the access networks 112 and 114 may comprise Digital Subscriber Line (DSL) networks, public switched telephone network (PSTN) access networks, broadband cable access networks, Local Area Networks (LANs), wireless access networks (e.g., an IEEE 802.11/Wi-Fi network and the like), cellular access networks, 3^{rd} party networks, and the like. For example, the operator of the core network 102 may provide a cable television service, an IPTV service, or any other types of telecommunication services to subscribers via access networks 112 and 114. In one example, the access networks 112 and 114 may comprise different types of access networks, may comprise the same type of access network, or some access networks may be the same type of access network and other may be different types of access networks. In one example, the core network 102 may be operated by a telecommunication network service provider or by a streaming media service provider. The core network 102 and the access networks 112 and 114 may be operated by different service providers, the same service provider or a combination thereof, or the access networks 112 and 114 may be operated by entities having core businesses that are not related to telecommunications services, e.g., corporate, governmental, or educational institution LANs, and the like.

In one example, the access network 112 may be in communication with one or more user endpoint (UE) devices 116 and 118. Similarly, access network 114 may be in communication with one or more UE devices 120 and 122. Access networks 112 and 114 may transmit and receive communications between UE devices 116, 118, 120, and 122, between UE devices 116, 118, 120, and 122 and media distribution system 104, DBs 108 and 110, and/or other components of the core network 102, devices reachable via the Internet in general, and so forth. In one example, each of UE devices 116, 118, 120, and 122 may comprise any single device or combination of devices that may comprise a user endpoint device. For example, the UE devices 116, 118, 120, and 122 may each comprise a mobile device, a cellular smart phone, a gaming console, a set top box, a laptop computer, a tablet computer, a desktop computer, an application server, a bank or cluster of such devices, and the like.

In accordance with the present disclosure, the media distribution system 104 may comprise a system that performs processing on an input source media (e.g., a video) to produce as an output a processed media for distribution to consumers (e.g., via UE devices 116, 118, 120, and 122). For instance, where the source media and the processed media are video streams, the media distribution system 104 may comprise a plurality of devices for performing various video processing and pre-processing stages 132₁-132₀ (hereinafter individually referred to as a “processing stage 132” or collectively referred to as “processing stages 132”). These processing and pre-processing stages 132 may include, for example, scaling, deinterlacing, denoising, compression, transcoding to one or more different bitrates, and/or other processing stages. In one example, the video streams may be live (e.g., not prerecorded video streams) that are processed in real time by the media distribution system 104. That is, an input data stream 126 comprising the source video may be continuously received by the media distribution system 104, which may process the source video through the various processing stages 132 as the input data stream is received and may distribute an output data stream 128 comprising the processed video as the processing stages 132 are completed. In other words, there may be little to no delay (e.g., save for network latency and/or processing time) between the processing of the input data stream 126 and the distribution of the output data stream 128.

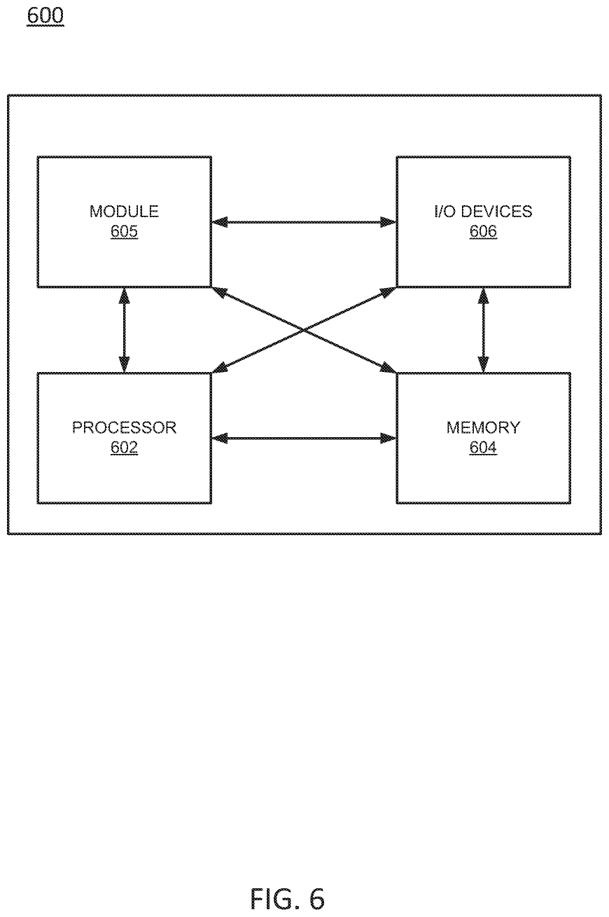

In accordance with the present disclosure, the AS 106 may comprise a computing system or server, such as computing system 600 depicted in FIG. 6, and may be configured to provide one or more operations or functions in connection with examples of the present disclosure for scene cut-based time alignment of video streams, as described herein.

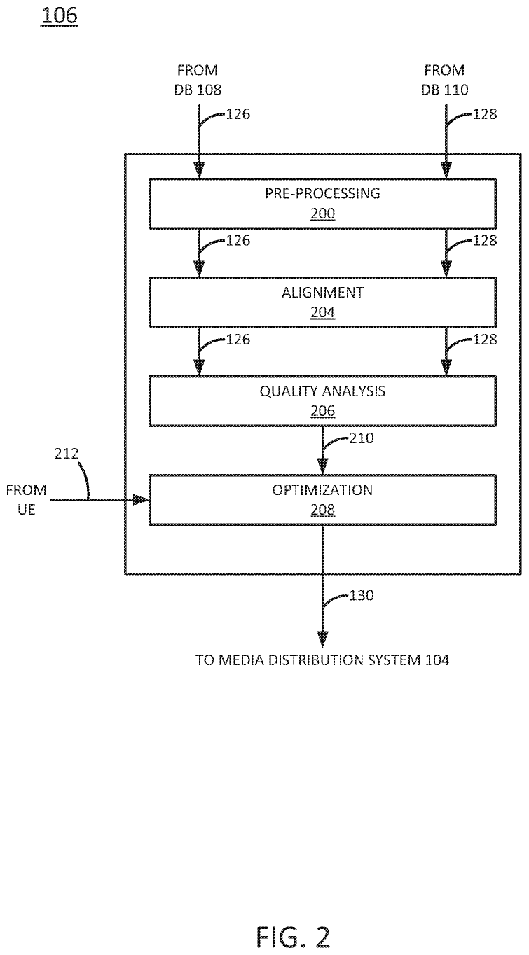

FIG. 2 is a block diagram illustrating one example of the application server 106 of FIG. 1, according to the present disclosure. In one example, the application server 106 may comprise a plurality of processing systems, including a pre-processing system 200, an alignment system 204, a quality analysis system 206, and an optimization system 208.

For instance, the pre-processing system 200 may be programmed to pre-process the source videos in the input data streams 126 received by the media distribution system 104 and the processed videos in the output data streams 128 distributed by the media distribution system 104. The pre-processing may include one or more processing techniques that condition the source videos and the processed videos for better alignment by the alignment system 204. For instance, the pre-processing may include bringing the source video and the processed video to the same frame rate (which may be required if the frame rate changes from the source video to the processed video). Alternatively or in addition, the pre-processing may include re-scaling the source video and the processed video to the same pixel resolution, bringing the source video and the processed video to the same scan type (e.g., progressive or interlaced), cropping or padding at least one of the source video and the processed video, and/or other pre-processing techniques.

The alignment system 204 may be programmed to align a source video in the input data streams 126 with a corresponding processed video in the output data streams 128. As discussed in further detail below, in one example, the alignment system 204 may detect the same scene cut or sequence of scene cuts in the source video and in the processed video, and may align the source video and the processed video using the scene cut as a reference point. This ensures that a subsequent comparison of the respective video qualities of the source video and the processed video is comparing the same portions (e.g., sequences of frames) of the videos.

The quality analysis system 206 may be programmed to compare the input data streams 126 to the corresponding, aligned output data streams 128 in order to verify that a quality of the media contained in the streams 126 and 128 is maintained. As an example, where the input data stream 126 and the output data stream 128 contain video, the quality analysis system 206 may compare a picture quality of the video in the input data stream 126 to a picture quality of the video in the output data stream 128. For instance, the quality analysis system 206 may compute a picture quality metric for each of the source video and the processed video. The quality analysis system 206 may further compute a difference 210 between the picture quality metric of the source video and the picture quality metric of the processed video, where the difference 210 indicates how much degradation, if any, of the source video has occurred.

When the quality analysis system 206 computes a difference 210 in the picture quality metric that exceeds a predefined threshold, the quality analysis system 206 may output the difference to the optimization system 208. The optimization system 208 may be configured to perform an optimization process that determines an adjustment to the configuration of at least one processing stage 132 of the media distribution system 104, where the adjustment is expected to result in an improvement to the quality of the output data stream 128 (e.g., to minimize the difference 210). The adjustment may be computed based on the picture quality metric for the source video, the picture quality metric for the processed video, and optionally on any constraints 212 that may be specified by a user.

The optimization system 208 may send a signal 130 to the media distribution system 104, where the signal 130 encodes the computed adjustment(s) to be made to the processing stage(s) 132. Thus, the media distribution system 104 may apply at least one computed adjustment to adjust the processing of the input data stream 126 going forward.

Referring back to FIG. 1, the first DB 108 may be accessible by both the media distribution system 104 and the AS 106 and may store source media that is to be processed by the media distribution system 104 prior to distribution to consumers. For instance, when the media distribution system 104 is to process the source media, the first DB 108 may provide the source media as an input data stream 126 to the media distribution system 104. Similarly, when the AS 106 is to measure the quality of the media in the output data stream 128, the first DB 108 may provide the source media as an input data stream 126 to the AS 106 for comparison as discussed above.

The second DB 110 may also be accessible by both the media distribution system 104 and the AS 106 and may store processed media that has been processed by the media distribution system 104 and is ready for distribution to consumers. For instance, when the media distribution system 104 has processed the source media, the media distribution system 104 may provide the processed media to the second DB 110 as an output data stream 128. UE devices 112, 118, 120, and 122 may subsequently access the processed media via the second DB 110. Similarly, when the AS 106 is to measure the quality of the media in the output data stream 128, the second DB 110 may provide the processed media as an output data stream 128 to the AS 106 for comparison to the source media as discussed above.

In one example, the first DB 108 and the second DB 110 may comprise a single DB. The DBs 108 and 110 may store data locally (e.g., on local disks), or the DBs 108 and 110 may be distributed across a plurality of hosts (e.g., as long as network connectivity allows). In a further example, the core network 102 may not include a database at all; for instance, the stored data may be stored locally by the AS 106. In one example, each of the first DB 108 and the second DB 110 may comprise a circular buffer of a defined duration.

In accordance with the present disclosure, the AS 106 may comprise one or more physical devices, e.g., one or more computing systems or servers, such as computing system 600 depicted in FIG. 6, and may be configured to provide one or more operations for scene cut-based time alignment of video streams, as described herein. It should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 6 and discussed below) or multiple computing devices collectively configured to perform various steps, functions, and/or operations in accordance with the present disclosure.

Moreover, the AS 106 may be implemented as a standalone system, in an enterprise data center, in a public or private data center, in a public or private hosting center, and/or in any one or more other systems for running applications in the cloud.

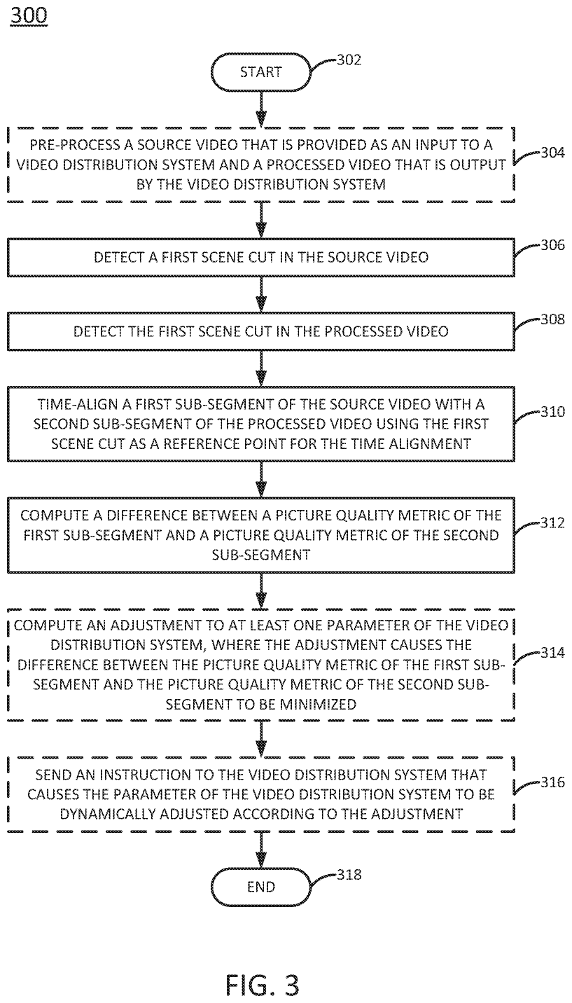

In one example, DBs 108 and 110 may comprise physical storage devices integrated with the AS 106 (e.g., a database server or a file server), or attached or coupled to the AS 106, to store media streams, in accordance with the present disclosure. In one example, the AS 106 may load instructions into a memory, or one or more distributed memory units, and execute the instructions for scene cut-based time alignment of video streams, as described herein. An example method for scene cut-based time alignment of video streams is described in greater detail below in connection with FIG. 3.

It should be noted that examples of the present disclosure may operate from almost any location in a network. For example, the system embodied in the AS 106 may operate from a source premises (e.g., a source of the source media, such as a media production company), a distributor premises (e.g., a media distribution channel through which the processed media is distributed to consumers), or a third party premises (where the third party may offer support services for monitoring the quality of processed media). Examples of the present disclosure may also be implemented in a hosting center or in cloud services in a variety of mechanisms (e.g., virtual machines, containers, virtual private servers, and/or the like).

It should be noted that the system 100 has been simplified. Thus, those skilled in the art will realize that the system 100 may be implemented in a different form than that which is illustrated in FIG. 1, or may be expanded by including additional endpoint devices, access networks, network elements, application servers, etc. without altering the scope of the present disclosure. In addition, system 100 may be altered to omit various elements, substitute elements for devices that perform the same or similar functions, combine elements that are illustrated as separate devices, and/or implement network elements as functions that are spread across several devices that operate collectively as the respective network elements. For example, the system 100 may include other network elements (not shown) such as border elements, routers, switches, policy servers, security devices, gateways, a content distribution network (CDN) and the like. For example, portions of the core network 102, access networks 112 and 114, and/or Internet 124 may comprise a content distribution network (CDN) having ingest servers, edge servers, and the like for packet-based streaming of video, audio, or other content. Similarly, although two access networks, 112 and 114, are shown, in other examples, access networks 112 and 114 may each comprise a plurality of different access networks that may interface with the core network 102 independently or in a chained manner. For example, UE devices 116, 118, 120, and 122 may communicate with the core network 102 via different access networks, UE devices 116, 118, 120, and 122 may communicate with the core network 102 via different access networks, and so forth. Thus, these and other modifications are all contemplated within the scope of the present disclosure.

FIG. 3 is a flowchart illustrating one example of a method 300 for measuring the picture quality of a video stream, in accordance with the present disclosure. In one example, the method 300 is performed by an application server such as the AS 106 of FIGS. 1 and 2, or any one more components thereof, such as a processing system, or by an application server in conjunction with other devices and/or components of network 100 of FIG. 1. In one example, the steps, functions, or operations of method 300 may be performed by a computing device or system 600, and/or a processing system 602 as described in connection with FIG. 6 below. For instance, the computing device 600 may represent any one or more components of an application server configured to perform the steps, functions and/or operations of the method 300. For illustrative purposes, the method 300 is described in greater detail below in connection with an example performed by a processing system, such as processing system 602. The method 300 begins in step 302 and proceeds to step 304.

In optional step 304 (illustrated in phantom), the processing system may pre-process a source video that is provided as an input to a video distribution system and a processed video that is output by the video distribution system. In one example, the video distribution system is a live, linear video distribution system that processes the source video for distribution to viewers in real time. That is, an input data stream comprising the source video may be continuously received by the video distribution system, which may process the source video through a plurality of processing stages as the input data stream is received. The video distribution system may distribute an output data stream comprising the processed source video as the processing stages are completed. In other words, there may be little to no delay (e.g., save for network latency and/or processing time) between the processing of the input data stream and the distribution of the output data stream.

As discussed above, the video distribution system may comprise a plurality of processing stages. In one example, the plurality of processing stages may include at least one of: scaling, deinterlacing, denoising, compression, and transcoding to one or more different bitrates. Each one of these processing stages may introduce a delay that causes a misalignment in time between the frames of the input data stream and the frames of the output data stream.

In one example, the pre-processing may comprise one or more processing techniques that condition the source video and the processed video for better alignment in later stages of the method 300. For instance, the pre-processing may include bringing the source video and the processed video to the same frame rate (which may be required if the frame rate changes from the source video to the processed video). Alternatively or in addition, the pre-processing many include re-scaling the source video and the processed video to the same pixel resolution, bringing the source video and the processed video to the same scan type (e.g., progressive or interlaced), cropping or padding at least one of the source video and the processed video, and/or other pre-processing techniques.

In step 306, the processing system may detect a first scene cut in the source video that is provided as the input to a video distribution system. The first scene cut that is detected in the source video may comprise, for example, a transition from one shot to another (e.g., as when the source video switches from one camera shot to another in a single scene, switches from one scene to another, or even switches between programming, such as might occur when switching from a main program to a commercial).

In one example, the first scene cut may be detected in the source video by performing pixel-wise frame differencing between sequential (e.g., adjacent) frames of the same sequence of frames of the source video. Thus, a window of sequential frames may be selected from the source video, and a pixel-wise frame difference may be computed for each pair of sequential frames in the window. If the pixel-wise frame difference between a pair of sequential frames comprising a first frame and a second frame is larger than a predefined threshold frame difference, then this indicates a high probability that the second frame of the pair belongs to a different scene than the first frame. In other words, a scene cut may exist between the first frame and the second frame. In one example, open source tools may be used to extract the first scene cut from the source video. In another example, where the source video is a known source video (e.g., a video that is being played out of a playout server), the first scene cut may be determined offline and provided to the processing system.

In step 308, the processing system may detect the first scene cut in the processed video that is output by the video distribution system, where the processed video comprises a version of the source video that has been altered according to at least one processing stage of the plurality of processing stages in order to make the processed video suitable for distribution to viewers. In other words, the same scene cut that is detected in the source video is also detected in the processed video. The first scene cut may also be detected in the processed video in the same way that the first scene cut is detected in the source video (e.g., by pixel-wise frame differencing over a window of sequential frames of the processed video).

In step 310, the processing system may time-align a first sub-segment of the source video with a second sub-segment of the processed video, using the first scene cut as a reference point for the time alignment. More specifically, the processing system may time-align the first sub-segment of the source video with the second sub-segment of the processed video by finding the largest contiguous sub-segments of the source video and the processed video (e.g., the first sub-segment and a second sub-segment, respectively) that have perfectly aligned scene cuts. One of these perfectly aligned scene cuts may be the first scene cut. Another of the perfectly aligned scene cuts may be a second scene cut that is different from the first scene cut and that occurs in both the source video and the processed video. Thus, each of the first sub-segment and the second sub-segment may occur, in its respective video (e.g., source video or processed video) between the first scene cut and the second scene cut. Put another way, the first sub-segment and the second sub-segment may each be bounded by the same scene cuts, i.e., the first scene cut and the second scene cut, in the respective video.

In one example, all of the detected scene cuts in the source video and the processed video (e.g., including the first scene cut as detected in steps 306 and 308) may be stored as frame numbers (e.g., the frame numbers at which the scene cuts occur), timecodes (e.g., the timestamps at which the scene cuts occur), standard clock time values (e.g., how many minutes, seconds, and/or the like from the starts of the videos the scene cuts occur), or other identifiers that uniquely identify the locations of the scene cuts.

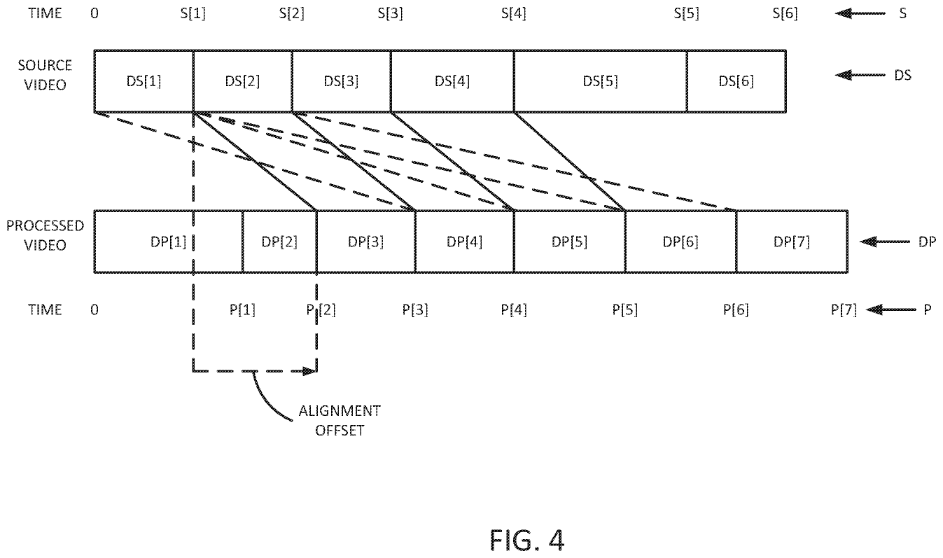

FIG. 4 is a diagram illustrating how an example source video may be time-aligned with an example processed video based on scene cuts, according to the present disclosure. In one example, a first plurality of locations, e.g., the locations of a first plurality of scene cuts (including the first scene cut and the second scene cut, discussed above) in the source video, may be inserted into a first array S, where S[n] denotes the time of the nth scene cut in the source video. Similarly, a second plurality of locations, e.g., the locations of a second plurality of scene cuts (including the first scene cut and the second scene cut, discussed above) in the processed video, may be inserted into a second array P, where P[m] denotes the time of the nth scene cut in the processed video. In one example, the first array S and the second array P may be different lengths, as shown.

The scene cuts for a sequence of X frames can be determined using on the order of X pixel-wise frame difference calculations. Thus, in one example, the total number of pixel-wise frame difference calculations required to generate the first array S and the second array P may be on the order of N+M (for a source sequence of N frames, and a processed sequence of M frames), which is significantly smaller than the N×M×W pixel-wise frame difference calculations utilized by conventional methods for time aligning source and processed video streams, as discussed above.

Once the locations of the scene cuts are inserted into the first array S and the second array P, the processing system may determine the scene cut intervals (e.g., the numbers of frames between the scene cuts, or durations of time of video sequences or sub-segments between the scene cuts) by computing the differences between the nth and the (n−1)th scene cut times in the first array S and between the mth and the (m−1)th scene cut times in the second array P. In other words, the number of frames between each sequential (or adjacent) pair of scene cuts is determined. The scene cut intervals may be inserted into a third array DS[n] for the source video and a fourth array DP[m] for the processed video. For example, referring to FIG. 4, the scene cut intervals DS[1] and DP[1] are set to the times S[1] and P[1], respectively. Similarly, the scene cut intervals DS[2] and DP[2] are set to the times S[2] and P[2], respectively, and so on.

In the example illustrated in FIG. 4, the scene cut interval DP[4] in the processed video is equal to the scene cut interval DS[1] in the source video; the scene cut interval DP[3] in the processed video is equal to the scene cut interval DS[2] in the source video; the scene cut interval DP[4] in the processed video is equal to the scene cut interval DS[3] in the source video; the scene cut interval DP[5] in the processed video is equal to the scene cut interval DS[4] in the source video; and the scene cut interval DP[6] in the processed video is equal to the scene cut interval DS[2] in the source video. It is probable that there will be a few matching scene cut intervals whose matches are not robust; however, examples of the present disclosure are able to detect the robust matches and discard the matches that are not robust. In the example illustrated in FIG. 4, robust matches are connected by solid lines between the third array DS and the fourth array DP; non-robust matches are connected by dashed lines.

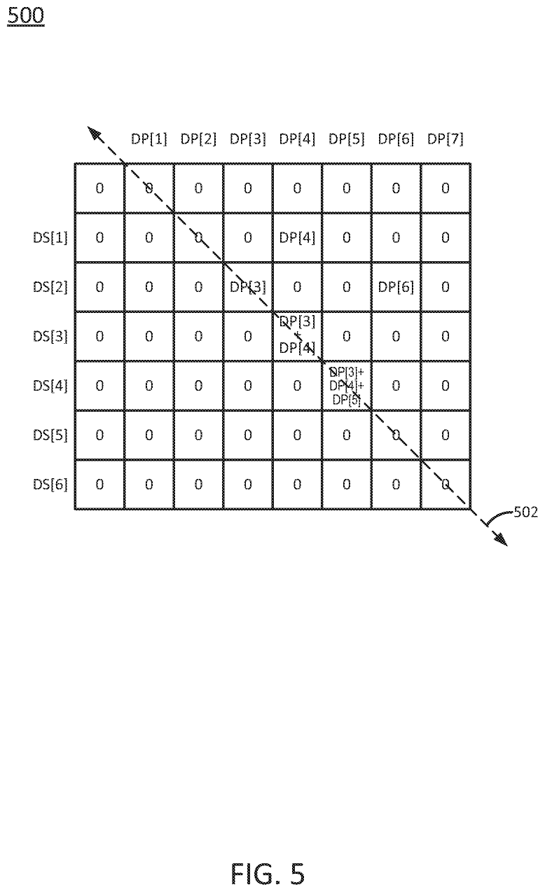

Once the robustly matching scene cut intervals have been detected, the processing system may populate a commonality matrix. FIG. 5 illustrates one example of a commonality matrix 500 that may be used to detect matching scene cuts in a source video and a corresponding processed video, according to the present disclosure. As illustrated, the commonality matrix 500 is an (N+1)×(M+1) matrix, where N is the number of scene cuts in the source video, and M is the number of scene cuts in the processed video. The first row and the first column of the commonality matrix 500 are set to zero as an initialization step. Each subsequent column corresponds to one scene cut interval in the processed video DP[m], while each subsequent row corresponds to one scene cut interval DS[n] in the source video.

After the first row and the first column of the commonality matrix 500 are set to zero, each remaining element of the commonality matrix 500 may be scanned row-by-row from left to right. For each element (i,j) of the commonality matrix 500 (where i denotes the row number started from zero and j denotes the column number starting from zero) if the corresponding scene cut interval of source video DS[i] is equal to the corresponding scene cut interval of the processed video DP[j], then the matrix element CM[i,j] is set to the sum of CM[i−1, j−1]+DP[j]. However, if the corresponding scene cut interval of source video DS[i] is not equal to the corresponding scene cut interval of the processed video DP[j], then the matrix element CM[i,j] is set to zero.

For instance, looking at FIG. 5, the matrix element CM[2,3] at the intersection of the scene cut intervals DS[2] and DP[3] is set to DP[3]. The matrix element CM[3,4] at the intersection of the scene cut intervals DS[3] and DP[4] is set to DP[3]+DP[4]. The matrix element CM[4,5] at the intersection of the scene cut intervals DS[4] and DP[5] is set to DP[3]+DP[4]+DP[5]. The matrix element CM[1,4] at the intersection of the scene cut intervals DS[1] and DP[4] is set to DP[4]. The matrix element CM[2,6] at the intersection of the scene cut intervals DS[2] and DP[6] is set to DP[6].

Once the commonality matrix 500 has been populated to contain the information about the matching scene cut intervals, it is relatively straightforward to identify the most robust scene cut alignments. In general, the matrix element CM[i,j] containing the largest value will indicate the longest sequence of scenes that matches between the source video and the processed video (e.g., the largest common sub-segment shared by the source video and the processed video). Thus, in one example, the matrix elements may be sorted in decreasing order so that the longest matching sequences of scenes appear at the top of the list.

In the example of FIG. 5, the matrix element CM[4,5] contains the largest value in the commonality matrix 500, i.e., DP[3]+DP[4]+DP[5]. The value DP[3]+DP[4]+DP[5] thus represents the amount of aligned time between the source video and the processed video, starting from the scene cut that occurs at time S[1] in the source video and time P[2] in the processed video, and ending at the scene cut that occurs at time S[4] in the source video and time P[5] in the processed video. The aligned sequence can be identified by following a diagonal path 502 through the commonality matrix 500 from the matrix element CM[4,5] back to the first occurring non-zero matrix element in the path 502 (i.e., CM[2,3]), or by subtracting the largest value (i.e., DP[3]+DP[4]+DP[5]) from the time point S[4] in the source video and from the time point P[5] in the processed video.

In one example, additional common or aligned sub-segments can be identified in addition to the largest common sub-segment. These additional aligned sub-segments may be identified in order of the durations of the aligned sequences by looking at the remaining non-zero values contained in the matrix which are not already part of an identified common sub-segment. For instance, in the commonality matrix 500 of FIG. 5, the value DP[6] in the matrix element CM[2,6] indicates that the scene cut interval from time S[1] to time S[2] in the source video is aligned with the scene cut interval from time P[5] to time P[6] in the processed video. Thus, these scene cut intervals may represent additional potentially aligned sub-segments.

As discussed above, less robust aligned sub-segments may also be identified and discarded (i.e., not considered for use in aligning the source video with the processed video). In one example, sub-segments that do not meet at least a threshold for robustness may be identified in one or more of a number of ways. For instance, in one example, a predefined threshold may define a minimum duration for an aligned sub-segment, where any aligned sub-segments whose durations fall below the predefined threshold may be discarded. In another example, when two aligned sub-segments overlap each other, the shorter of the two aligned sub-segments may be discarded. In another example, the first frame of an aligned sub-segment in the source video may be compared to the first frame of the aligned sub-segment in the processed video. If the first frames do not match to within some predefined threshold (e.g., a pixel-wise frame difference is not below a predefined threshold), then the aligned sub-segment may be discarded. In another example (where synchronized audio is available for both the source video and the processed video), a cross correlation may be performed for the aligned sub-segment in order to determine whether the audio of the sub-segment in the source video matches the audio of the sub-segment in the processed video. If the audio does not match, then the aligned sub-segment may be discarded.

In a further example still, any aligned sub-segments that are sufficiently robust (e.g., that are not discarded) may be further examined in order to determine whether the aligned sub-segments can be concatenated to form any even larger sub-segment. In one example, the aligned sub-segments that are potentially eligible for concatenation may first be sorted in temporal order (e.g., order of occurrence) of the processed video (in another example, if the processed video is not taken from a looping source, then the aligned sub-segments may be sorted in temporal order of the source video). Then, the interval between two sequential (e.g., adjacent in the sorting) aligned sub-segments may be computed for both the source video and the processed video. If the interval between the two sequential aligned sub-segments is the same in both the source video and the processed video, then the two sequential aligned sub-segments may be concatenated (including the interval between the sub-segments) to form one larger sub-segment.

The discarded sub-segments may indicate parts of the processed video that cannot be aligned with the source video due to errors such as dropped frames, frozen frames, incorrect timing in the processed video, or other errors. For instance, the processing system may detect a second scene cut in the source video and in the processed video, such that a third sub-segment of the source video and a fourth sub-segment of the processed video are each bounded by both the first scene cut and the third scene cut. The processing system may further determine that a first offset (e.g., number of seconds, number of frames, or the like) between the source video and the processed video for the first scene cut is different than a second offset between the source video and the processed video for the third scene cut. In this case, the third and fourth sub-segments may be discarded in response to the determination that the first and second offsets do not match, because the processing system will not be able to properly align the third and fourth sub-segments for reliable frame-by-frame comparison. In addition, the detection of these non-matching sub-segments may trigger the processing system to generate an alarm (e.g., that is sent by the video alignment system 204 in FIG. 2, above, to the quality analysis system 206) to indicate that non-matching sub-segments have been detected in the processed video.

Furthermore, if no robust sub-segments are detected using the methods discussed above (e.g., due to the source video not including any scene cuts during the tested duration), then the video alignment system may fall back on one or more traditional video alignment methods (such as pixel-wise frame differencing between the source video and the processed video).

Referring back to FIG. 3, in step 312, the processing system may compute a difference between a picture quality metric of the first sub-segment (of the source video) and a picture quality metric of the second sub-segment (of the processed video). Thus, the processing system may compute an objective picture quality metric for the first sub-segment (i.e., sequence of frames) in the source video and then compute the objective picture quality metric for the aligned second sub-segment (i.e., sequence of frames) in the processed video. If the objective picture quality metric for the first sub-segment matches the objective picture quality metric for the second sub-segment within some threshold (e.g., is within x percent of the objective picture quality metric for the first sub-segment, or the difference is less than a predefined threshold), then the picture quality for the processed video may be considered acceptable. However, if the objective picture quality metric for the first sub-segment does not match the objective picture quality metric for the second sub-segment (e.g., is not within x percent of the objective picture quality metric for the first sub-segment, or the difference is above the predefined threshold), then the picture quality for the processed video may be considered unacceptable.

In one example, the objective picture quality metrics may be compared and aggregated over a plurality of aligned sub-segments of the source video and the processed video. In another example, however, the objective picture quality metric may be compared over a single aligned sub-segment (e.g., the largest aligned sub-segment).

In one example, the objective picture quality metric is at least one of: VMAF, SSIM, and PSNR. Depending upon the objective of the system, one or more of these objective picture quality metrics may be used. For instance, PSNR, which is based on the mean square error between all pixels in a pair of images, is considered computationally simple, but tends to produce results that are inconsistent with the human visual system (HVS). SSIM, which is based on structural similarities between a pair of images, is more computationally intense, but also produces results that are better correlated to the HVS. VMAF, which is open source and free to use, combines principles from a plurality of different metrics (including, for instance, information fidelity, detail loss, and temporal information). VMAF is more computationally intense than both PSNR and SSIM, but the results correlate better with the HVS. Thus, the objective picture quality metric or metrics that are used in step 312 may be selected based on the available computational resources and the desired confidence in the results.

As part of the comparison, the processing system may compute a plurality of statistics including mean, harmonic mean, standard deviation, minimum, maximum, and histogram of the objective picture quality scores.

In optional step 314 (illustrated in phantom), the processing system may compute an adjustment to at least one parameter of the video distribution system, where the adjustment causes the difference between the picture quality metric of the first sub-segment and the picture quality metric of the second sub-segment to be minimized (e.g., smaller than the predefined threshold). For instance, in one example, one or more processing stages of the video distribution system may have multiple possible settings. In one example, for one of these processing stages, the video output (processed video) of the specific processing stage (as opposed to the output of the video distribution system as a whole) may be compared to the source video, and the configuration of the processing stage that maximizes the quality of the processing stage's video output (e.g., minimizes the difference between the source video and the processing stage's video output) may be selected by the processing system. The selection of the configuration may be subject to additional constraints such as bandwidth, resolution, source type, computing resources, and the like. In one example, adjustments may be continuously computed by the processing system in order to minimize the difference subject to at least one of these constraints.

In another example, adjustments may be computed for each processing stage of the video distribution system, by adapting the video picture quality metric of the processed video and other data such as key performance indicators from the user endpoint devices that receive the processed video. In another example still the processing system may utilize a machine learning technique that takes as inputs key performance indicators from the user endpoint devices, objective video picture quality metrics from the video distribution system, and other data and outputs an optimal video processing configuration that maximizes the objective video picture quality metric and the key performance indicators.

In optional step 316 (illustrated in phantom), the processing system may send an instruction to the video distribution system that causes the parameter to be dynamically adjusted according to the adjustment computed in step 314. For instance, the adjustment may be encoded in an electronic signal that is sent to the video distribution system, or to a specific processing stage of the video distribution system (e.g. a processing stage whose parameters are being adjusted). The signal may allow the parameters of the processing stage(s) to be adjusted in real time, thereby improving the picture quality of the processed video in real time. The method 300 may end in step 318.

In addition, although not expressly specified above, one or more steps of the method 300 may include a storing, displaying and/or outputting step as required for a particular application. In other words, any data, records, fields, and/or intermediate results discussed in the method can be stored, displayed and/or outputted to another device as required for a particular application. Furthermore, operations, steps, or blocks in FIG. 3 that recite a determining operation or involve a decision do not necessarily require that both branches of the determining operation be practiced. In other words, one of the branches of the determining operation can be deemed as an optional step. In addition, one or more steps, blocks, functions, or operations of the above described method 300 may comprise optional steps, or can be combined, separated, and/or performed in a different order from that described above, without departing from the example embodiments of the present disclosure. For instance, in one example the processing system may repeat one or more steps of the method 300. The method 300 may also be expanded to include additional steps. Thus, these and other modifications are all contemplated within the scope of the present disclosure.

FIG. 6 depicts a high-level block diagram of a computing device or processing system specifically programmed to perform the functions described herein. For example, any one or more components or devices illustrated in FIG. 1 or described in connection with the method 300 may be implemented as the system 600. As depicted in FIG. 6, the processing system 600 comprises one or more hardware processor elements 602 (e.g., a central processing unit (CPU), a microprocessor, or a multi-core processor), a memory 604 (e.g., random access memory (RAM) and/or read only memory (ROM)), a module 605 for scene cut-based time alignment of video streams, and various input/output devices 606 (e.g., storage devices, including but not limited to, a tape drive, a floppy drive, a hard disk drive or a compact disk drive, a receiver, a transmitter, a speaker, a display, a speech synthesizer, an output port, an input port and a user input device (such as a keyboard, a keypad, a mouse, a microphone and the like)). Although only one processor element is shown, it should be noted that the computing device may employ a plurality of processor elements. Furthermore, although only one computing device is shown in the figure, if the method 300 as discussed above is implemented in a distributed or parallel manner for a particular illustrative example, i.e., the steps of the above method 300, or the entire method 300 is implemented across multiple or parallel computing devices, e.g., a processing system, then the computing device of this figure is intended to represent each of those multiple computing devices.

Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented. The hardware processor 602 can also be configured or programmed to cause other devices to perform one or more operations as discussed above. In other words, the hardware processor 602 may serve the function of a central controller directing other devices to perform the one or more operations as discussed above.

It should be noted that the present disclosure can be implemented in software and/or in a combination of software and hardware, e.g., using application specific integrated circuits (ASIC), a programmable gate array (PGA) including a Field PGA, or a state machine deployed on a hardware device, a computing device or any other hardware equivalents, e.g., computer readable instructions pertaining to the method discussed above can be used to configure a hardware processor to perform the steps, functions and/or operations of the above disclosed method 300. In one example, instructions and data for the present module or process 605 for scene cut-based time alignment of video streams (e.g., a software program comprising computer-executable instructions) can be loaded into memory 604 and executed by hardware processor element 602 to implement the steps, functions, or operations as discussed above in connection with the illustrative method 300. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method can be perceived as a programmed processor or a specialized processor. As such, the present module 605 for scene cut-based time alignment of video streams (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette, and the like. Furthermore, a “tangible” computer-readable storage device or medium comprises a physical device, a hardware device, or a device that is discernible by the touch. More specifically, the computer-readable storage device may comprise any physical devices that provide the ability to store information such as data and/or instructions to be accessed by a processor or a computing device such as a computer or an application server.

While various examples have been described above, it should be understood that these examples have been presented by way of illustration only, and not a limitation. Thus, the breadth and scope of any aspect of the present disclosure should not be limited by any of the above-described examples, but should be defined only in accordance with the following claims and their equivalents.

What is claimed is:

1. A method comprising:
detecting, by a processing system, a first scene cut in a source video that is provided as an input to a video distribution system, wherein the video distribution system comprises a plurality of processing stages for transforming the source video into a processed video that is suitable for distribution to viewers;
detecting, by the processing system, the first scene cut in the processed video that is output by the video distribution system, wherein the processed video comprises a version of the source video that has been altered according to at least one processing stage of the plurality of processing stages;
time-aligning, by the processing system, a first sub-segment of the source video with a second sub-segment of the processed video, using the first scene cut as a reference point for performing the time-aligning; and
computing, by the processing system, a difference between a picture quality metric of the first sub-segment and a picture quality metric of the second sub-segment.

2. The method of claim 1, wherein the detecting the first scene cut in the source video comprises:
computing, by the processing system, a pixel-wise frame difference between a pair of sequential frames of the source video; and
identifying, by the processing system, the first scene cut when the pixel-wise frame difference is larger than a predefined threshold.

3. The method of claim 1, wherein the first sub-segment comprises a first plurality of sequential frames of the source video that occurs between the first scene cut and a second scene cut, and wherein the second sub-segment comprises a second plurality of sequential frames of the processed video that occurs between the first scene cut and the second scene cut.

4. The method of claim 3, wherein a duration of the first plurality of sequential frames is equal to a duration of the second plurality of sequential frames.

5. The method of claim 4, wherein a number of frames of the first plurality of sequential frames is calculated by:
inserting, by the processing system, a first plurality of locations into a first array, wherein each location of the first plurality of locations indicates a location of one scene cut of a first plurality of scene cuts in the source video, and wherein the first plurality of scene cuts includes the first scene cut and the second scene cut; and
computing, by the processing system, the number of frames in the first plurality of frames as a number of frames occurring in the array between the first scene cut and the second scene cut.

6. The method of claim 1, wherein the first sub-segment and the second-sub-segment are selected from among a plurality of pairs of sub-segments having aligned scene cuts, and wherein a duration of the first scene cut and the second scene cut is largest among the plurality of pairs of sub-segments having aligned scene cuts.

7. The method of claim 1, wherein the picture quality metric of the first sub-segment and the picture quality metric of the second sub-segment are computed using an objective picture quality metric.

8. The method of claim 7, wherein the objective picture quality metric is at least one of: a peak signal-to-noise ratio, a structural similarity, and a video multimethod assessment fusion.

9. The method of claim 1, further comprising:
determining, by the processing system, that the difference between the picture quality metric of the first sub-segment and the picture quality metric of the second sub-segment is greater than a predefined threshold;
computing, by the processing system, an adjustment to a parameter of the video distribution system, wherein the adjustment causes the difference between the picture quality metric of the first sub-segment and the picture quality metric of the second sub-segment to be smaller than the predefined threshold; and
sending, by the processing system, an instruction to the video distribution system, wherein the instruction causes the parameter to be dynamically adjusted according to the adjustment.

10. The method of claim 9, wherein the parameter comprises a setting of a processing stage of the plurality of processing stages.

11. The method of claim 9, wherein the parameter comprises a configuration of the plurality of processing stages that minimizes the difference between the picture quality metric of the first sub-segment and the picture quality metric of the second sub-segment while maximizing at least one key performance indicator reported by a user endpoint device that receives the processed video.

12. The method of claim 9, wherein the adjustment accounts for at least one constraint that is specified by a user.

13. The method of claim 1, wherein the video distribution system is a linear video distribution system, and the at least one stage of the plurality of processing stages comprises at least one of: scaling, deinterlacing, denoising, compression, and transcoding.

14. The method of claim 1, wherein the source video comprises a live video stream, and the processed video is output by the video distribution system in real time.

15. The method of claim 1, further comprising, prior to the detecting the first scene cut in the source video and the detecting the first scene cut in the processed video:
performing, by the processing system, a pre-processing technique on the source video and on the processed video, wherein the pre-processing technique is at least one of: bringing the source video and the processed video to a same frame rate, re-scaling the source video and the processed video to a same pixel resolution, bringing the source video and the processed video to a same scan type, cropping at least one of the source video and the processed video, and padding at least one of the source video and the processed video.

16. The method of claim 1, further comprising:
detecting, by the processing system, a second scene cut in the source video and in the processed video, wherein the first sub-segment and the second sub-segment are each bounded by both the first scene cut and the second scene cut.

17. The method of claim 16, further comprising:
detecting, by the processing system, a third scene cut in the source video and in the processed video, wherein a third sub-segment of the source video and a fourth sub-segment of the processed video are each bounded by both the first scene cut and the third scene cut;
determining, by the processing system, that a first offset between the source video and the processed video for the first scene cut is different than a second offset between the source video and the processed video for the third scene cut;
discarding, by the processing system, the third sub-segment and the fourth sub-segment in response to the determining; and
generating, by the processing system, an alarm to indicate that the third sub-segment and the fourth sub-segment are non-matching sub-segments.

18. A device comprising:
a processing system including at least one processor; and
a computer-readable medium storing instructions which, when executed by the processing system, cause the processing system to perform operations, the operations comprising:
detecting a first scene cut in a source video that is provided as an input to a video distribution system, wherein the video distribution system comprises a plurality of processing stages for transforming the source video into a processed video that is suitable for distribution to viewers;
detecting the first scene cut in the processed video that is output by the video distribution system, wherein the processed video comprises a version of the source video that has been altered according to at least one processing stage of the plurality of processing stages;
time-aligning a first sub-segment of the source video with a second sub-segment of the processed video, using the first scene cut as a reference point for performing the time-aligning; and
computing a difference between a picture quality metric of the first sub-segment and a picture quality metric of the second sub-segment.

19. A non-transitory computer-readable medium storing instructions which, when executed by a processing system including at least one processor, cause the processing system to perform operations, the operations comprising:
detecting a first scene cut in a source video that is provided as an input to a video distribution system, wherein the video distribution system comprises a plurality of processing stages for transforming the source video into a processed video that is suitable for distribution to viewers;
detecting the first scene cut in the processed video that is output by the video distribution system, wherein the processed video comprises a version of the source video that has been altered according to at least one processing stage of the plurality of processing stages;
time-aligning a first sub-segment of the source video with a second sub-segment of the processed video, using the first scene cut as a reference point for performing the time-aligning;
computing a difference between a picture quality metric of the first sub-segment and a picture quality metric of the second sub-segment;
determining that the difference between the picture quality metric of the first sub-segment and the picture quality metric of the second sub-segment is greater than a predefined threshold;
computing an adjustment to a parameter of the video distribution system, wherein the adjustment causes the difference between the picture quality metric of the first sub-segment and the picture quality metric of the second sub-segment to be smaller than the predefined threshold; and
sending an instruction to the video distribution system, wherein the instruction causes the parameter to be dynamically adjusted according to the adjustment.

20. The non-transitory computer-readable medium of claim 19, wherein the computing and the sending are performed continuously in order to minimize the difference subject to at least one constraint.
